(19) United States
(12) Patent Application Publication
(10) Pub. No.: US 2023/0396523 A1
(43) Pub. Date: Dec. 7, 2023

(54) SYSTEMS AND METHODS TO MAP LOCALIZED WIRELESS COVERAGE

(71) Applicant: CenturyLink Intellectual Property LLC, Broomfield, CO (US)

(72) Inventors: Dean Ballew, Sterling, VA (US); John R.B. Woodworth, Amissville, VA (US)

(73) Assignee: CenturyLink Intellectual Property LLC, Broomfield, CO (US)

(21) Appl. No.: 18/327,492

(22) Filed: Jun. 1, 2023

Related U.S. Application Data
(60) Provisional application No. 63/365,980, filed on Jun. 7, 2022.

(51) Int. Cl. H04L 43/06; H04B 17/318

(52) U.S. Cl. CPC H04L 43/06; H04B 17/318

(57) ABSTRACT

When a user of a mobile telephone moves into an area lacking wireless service, the user may be hindered in various respects, including losing the ability to retrieve a remotely stored map. This may be inconvenient and may have safety implications if the user is in a remote area, e.g., hiking, or in a disabled vehicle. As such, systems and methods to map localized wireless coverage are provided.

### CROSS-REFERENCE TO RELATED APPLICATIONS

This application claims the benefit of U.S. Provisional Application No. 63/365,980 filed Jun. 7, 2022, entitled “Systems and Methods to Map Localized Wireless Coverage,” which is incorporated herein by reference in its entirety.

### FIELD

One or more aspects of examples according to the present disclosure relate to mobile communications, and more particularly to systems and methods to map localized wireless coverage.

### BACKGROUND

When a user of a mobile telephone moves into an area lacking wireless service, the user may be handicapped in various respects, losing, for example, the ability to retrieve a map. This may be inconvenient and may have safety implications if the user is in a remote area, e.g., hiking, or in a disabled vehicle.

It is with respect to this general technical environment that aspects of the present disclosure are related.

### SUMMARY

Systems and methods to map localized wireless coverage are provided. In an aspect, a method includes recording, by a user device, a characteristic of a radio signal environment, and generating a report, by the user device, based on the recorded characteristic. The method may further include causing communication of radio signal information, wherein the radio signal information is based on the report.

In another aspect, a system is provided comprising a radio transceiver; at least one processing circuit; and memory, operatively connected to the at least one processing circuit and storing instructions that, when executed by the at least one processing circuit, cause the user device to perform a method. In examples, the method comprises: recording a characteristic of a radio signal environment; generating a report based on the recorded characteristic; and causing communication of radio signal information, wherein the radio signal information is based on the report.

In another aspect, a system comprising: at least one processing circuit; and memory, operatively connected to the at least one processing circuit and storing instructions that, when executed by the at least one processing circuit, cause the at least one processing circuit to perform a method. In examples, the method comprises: receiving, from a first user device, a first characteristic of a radio signal environment at a first location; receiving, from a second user device, a second characteristic of a radio signal environment at a second location; merging the first characteristic and the second characteristic into a regional radio environment model; and sending, to the first user device, a portion of the regional radio environment model, the portion being based on the location of the first user device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

These and other features and advantages of the present disclosure will be appreciated and understood with reference to the specification, claims, and appended drawings. Non-limiting and non-exhaustive examples are described with reference to the following Figures.

FIG. 1 is a block diagram of a system for mobile communications, according to an example of the present disclosure;

FIG. 2 is a schematic drawing of a graphical display of locations at which radio connectivity is expected to be available, according to an example of the present disclosure;

FIG. 3A is a flow chart of a method, according to an example of the present disclosure;

FIG. 3B is a flow chart of a method, according to an example of the present disclosure;

FIG. 3C is a flow chart of a method, according to an example of the present disclosure;

FIG. 3D is a flow chart of a method, according to an example of the present disclosure;

FIG. 3E is a flow chart of a method, according to an example of the present disclosure; and

FIG. 4 is a block diagram of an operating environment, according to an example of the present disclosure.

### DETAILED DESCRIPTION

The detailed description set forth below in connection with the appended drawings is intended as a description of exemplary embodiments of systems and methods to map localized wireless coverage provided in accordance with the present disclosure and is not intended to represent the only forms in which the present disclosure may be constructed or utilized.

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. In addition, all systems described with respect to the Figures can comprise one or more machines or devices that are operatively connected to cooperate in order to provide the described system functionality. The following detailed description is therefore not to be taken in a limiting sense, and the scope of the present disclosure is defined by the appended claims and their equivalents.

Mobile telephone service, or “cellular” service is generally readily available in urban areas but coverage may be sparse in rural and wilderness areas. A lack of cellular service in some areas may result in safety issues. For example, a person, such as a hiker or a motorist whose car has become disabled, may be unable to call for help, and the inability to retrieve a map through the person's mobile telephone may also impede her or his efforts to walk to a location where a cellular signal may be available. Moreover, even if the person has a map, she or he may not know in which direction to walk to find a cellular signal.

In some examples, in part to mitigate such problems, a user device, such as a mobile telephone, may collect and store, or “record” information about the electromagnetic environment or “radio environment” of the user device, and this information may later (when the user is in an area lacking a cellular signal) be used to help the user find a location at which radio connectivity (e.g., a cellular signal, or another electromagnetic signal that may be used for communicating) is available. Such information about the radio environment may include whether a cellular signal (or “mobile telephone” signal) is present, and, if so, (i) what the signal strength is, (ii) the identity of the carrier, and (iii) the modulation type (e.g., Code Division Multiple Access (CDMA), Global System for Mobiles (GSM) or Advanced Mobile Phone Service (AMPS)). Information about the identity of the carrier may include whether cellular service is provided by the principal carrier (the cellular carrier with which the user device is associated) or by a foreign carrier (with which the mobile telephone may be able to communicate only if roaming is enabled, or to make an emergency (e.g., 911) call). The information about the radio environment may also include, for example, whether a signal from an open (e.g., unsecured) WiFi access point station (AP STA) is present, and the strength of such a signal.

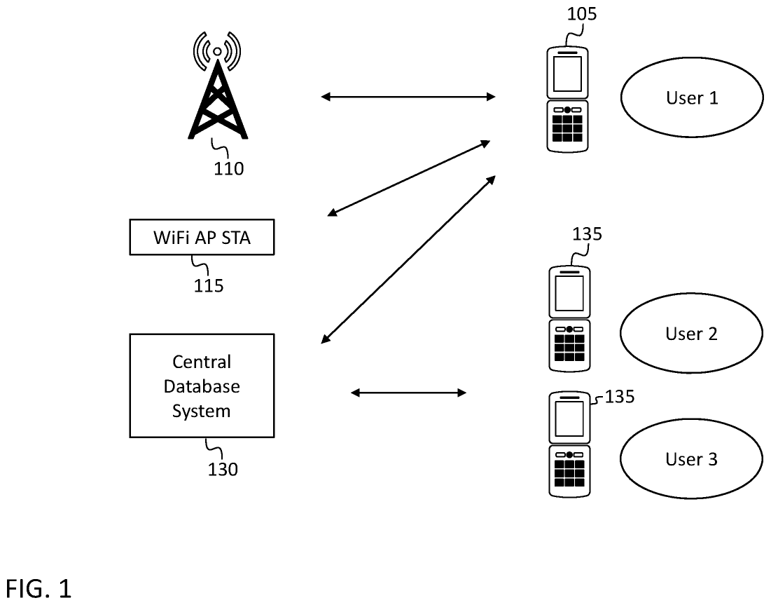

FIG. 1 shows an environment including the user device 105, a cellular network node 110, and a WiFi AP STA 115. The characteristics of the radio environment that are detected and recorded may depend on the capabilities of the user device 105. For example, if it includes a suitable radio receiver or transceiver, a user device 105 may, as mentioned above, detect cellular signals generated by its principal carrier, cellular signals generated by foreign carriers, or WiFi signals generated by open WiFi access points (or “access point stations” (AP STAs)); the user device 105 may also detect and store, as characteristics of the radio environment, information about any other signals that may be used for communication, such as Very High Frequency (VHF) or Ultra High Frequency (UHF) signals, e.g., communication signals in the Industrial, Scientific and Medical (ISM) frequency bands.

The user device 105 may record such information in an ongoing manner (e.g., whenever it is powered up) or whenever the feature is enabled by the user. For example, when driving to the trailhead of a hike, the user may start an application or function on the user device 105, which, when running, may periodically (e.g., every second or every 10 seconds or every minute, etc.) record information about the radio environment of the user device 105. It may also collect location data (e.g., Global Positioning System (GPS) data, or location data determined based on the propagation delays between the user device 105 and network nodes (e.g., cellular towers) of a cellular network), and it may correlate the information collected about the radio environment with the location data. It may further correlate the information collected about the radio environment with the time at which it was collected.

The information about the radio environment (and the location and time data with which it is correlated) may be stored locally, on the user device 105. During times when the user device 105 has radio connectivity (e.g., connectivity to the internet through a cellular connection or through a WiFi connection, or otherwise), the user device 105 may also exchange data with a coordination system 130. The coordination system 130 may include a database and one or more processing circuits; it may be centralized or distributed. The user device 105 and user devices 135 of other users, which may be distributed over a relatively large region, e.g., a state or a country, may generate reports of radio environment information and send (e.g., upload) the reports to the coordination system 130. The coordination system 130 may store this data, correlated with the time and position at which each piece of information was collected. A suitable algorithm (e.g., a machine learning or artificial intelligence algorithm) running in the coordination system 130 may generate, based on the information about the radio environment that it has received, a model (or “regional model”) of the radio environment, as a function of position, within the area. This regional radio environment model may also be based on other data (e.g., published locations of cellular towers, or topographic models), which may supplement the local radio environment reports received from user devices. A topographic model may be used, for example, to extrapolate local radio environment reports into areas (e.g., wilderness areas) in which few users are present or users are rarely present.

The regional radio environment model may include, for example, polygons drawn around geographic map locations at which the presence of a cellular signal of a certain carrier has been reported by a user device 105, 135, when such locations are sufficiently close together to have originated from a single cellular tower. The regional radio environment model may include parameterized functions (e.g., polynomial splines) fit to the reported data within the region. In some examples, the regional radio environment model includes a neural network trained with the reported radio environment information to predict the radio environment at any point in the area. The reliability of information about the radio environment may degrade over time, for example as new cellular towers, or buildings which may block cellular signals, are constructed. As such, the regional radio environment model may also include a confidence model, indicating, for example, for any point in the region, the confidence with which predictions about each signal in the radio environment can be made. The confidence may be high near a point at which a user device 105, 135 recently reported information about the radio environment, and the confidence may decrease with time after such a report.

In addition to periodically reporting the detected radio environment to the coordination system 130, the user device 105 may periodically download a portion (e.g., a local portion, covering an area with a radius between one mile and ten miles) of the regional radio environment model from the coordination system 130. The downloaded radio environment model may become a part of a locally stored radio environment model, which may be based in part on the downloaded portion of the regional radio environment model and in part on the information about the radio environment collected and stored locally by the user device 105. The user device 105 may treat data it itself collected as being more reliable than data received from the coordination system 130; e.g., it may weight data it collected itself more heavily when merging locally collected data and the downloaded portion of the regional radio environment model to form the locally stored radio environment model. The user device 105 may also periodically download (from the coordination system 130 or from another source, e.g., from a suitable web site) a map or satellite image of a local region (e.g., a region of radius five miles, centered on the user device 105).

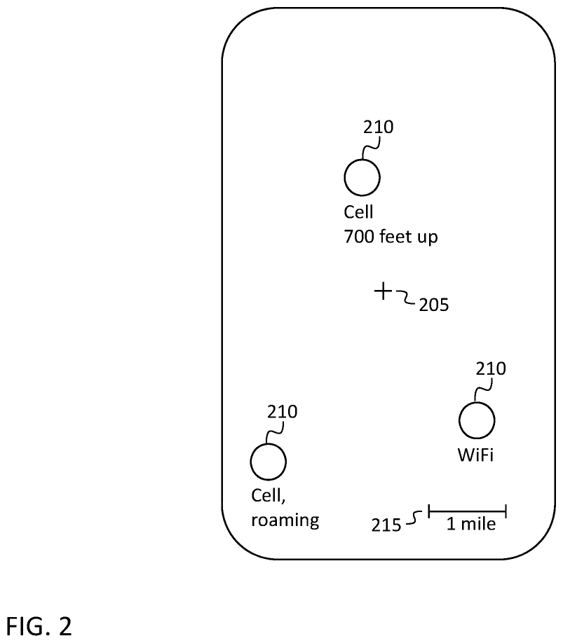

If the user subsequently loses radio connectivity (e.g., if the user loses cellular coverage), and needs to re-establish radio connectivity (e.g., if the user realizes that she or he has become lost), the user may request navigation assistance, from the application, in navigating to a location at which radio connectivity (e.g., a cellular signal or a WiFi signal) is expected to be available. From the locally stored radio environment model, the user device 105 may generate radio signal information, and cause the radio signal information to be communicated to the user. The radio signal information may include, for example, information about one or more locations at which radio connectivity is expected to be available. For example, in causing the radio signal information to be communicated to the user, the user device 105 may display the locations to the user in a graphical display, which may be referred to as a “radio environment diagram”, to help the user navigate to one or more of these locations. FIG. 2 shows a simplified example of such a graphical display. The user's position may be displayed (e.g., at the center of the display) using a position identifying mark 205 corresponding to the position of the user device 105, and location symbols 210, identifying locations at which radio connectivity is expected to be available, may also be shown, at positions on the display corresponding to the positions on the ground of the locations at which radio connectivity is expected to be available.

The locations for which the location symbols are displayed may be selected as ones at which a function of (i) the signal strength predicted by the locally stored radio environment model and (ii) the estimated confidence (that the locally stored radio environment model estimates for this signal level) exceeds a threshold. For example, for the principal carrier (if the function of the predicted signal strength and the estimated confidence is the product of the predicted signal strength and the estimated confidence), the user device 105 may find the nearest point at which the product of the signal strength and the estimated confidence exceeds a threshold, and, if the distance to this point is less than a threshold distance (e.g., a user-settable threshold distance, which may default to a value between 1 mile and 10 miles), display this point with a first location symbol 210. The user device 105 may also find and display other points which meet the signal strength, confidence, and distance requirements, and which are separated from the first point (and from any other points displayed for the principal carrier) by a minimum amount (e.g., which are separated from other displayed points for the principal carrier by at least a threshold distance, e.g., ¼ mile, or which are separated in angle, from other displayed points, by at least a threshold angle, e.g., 30 degrees). Requiring a minimum separation may prevent the user device 105 from displaying clusters of closely spaced points, which may confuse the user. As used herein, a first point and a second point are “separated in angle” by a first angle when the angle between (i) the direction from the user device 105 to the first point and (i) the direction from the user device 105 to the second point equals the first angle. This process of selecting points at which to display location symbols 210 may then be repeated for other signal types, e.g., for foreign carriers and for signals from open WiFi AP STAs.

The user device 105 may also display a scale marker 215 allowing the user to estimate the distance to the locations at which radio connectivity is expected to be available, and, for each of the location symbols 210 at which radio connectivity is expected to be available, it may display additional information, such as the elevation difference between the location and the user's location, or the signal type (e.g., principal carrier cellular, foreign carrier cellular, or WiFi) expected to be available.

If the user device 105 is able to estimate its orientation (e.g., using a compass in the user device 105, or using GPS/inertial navigation system (GPS/INS) estimation based on GPS position estimation, and on accelerometers, and gyroscopes in the user device 105), the displayed image may be displayed so as to remain fixed as the user device 105 is rotated, so that the displayed direction to a location at which radio connectivity is expected to be available remains fixed (relative to the user's environment). If the user device 105 lacks a compass and also lacks gyroscopes, then the user device 105 may instead draw the user's track as the user walks, so that the user may determine, when walking toward a location at which radio connectivity is expected to be available, whether she or he is walking in the correct direction, or should instead walk, e.g., slightly to the right or to the left. If a locally stored map (e.g., topographic map) or satellite image is available (as a result of having been downloaded as part of a periodic download performed before radio connectivity was lost), the user device 105 may superimpose the map or image on the radio environment diagram, to aid the user in navigating, or to allow the user to identify routes that may be convenient or difficult to use (e.g., a route part of which follows a fire road, or a route that crosses very steep terrain).

The system may employ one or more methods to avoid providing misleading information to the user when providing navigation assistance. For example, the coordination system 130 may be aware (e.g., as a result of a registration process performed when the user device 105 first contacts the coordination system 130) of the capabilities of the user device 105, and it may withhold from the user device 105 information about cellular signals produced by carriers with which the user device 105 is not compatible (e.g., it may withhold data about GSM signals from a user device 105 that has a radio not capable of communicating with a GSM network node). In another example, the user device 105 may also (or instead) perform this function, and ignore information, in the global radio environment model or in the locally stored radio environment model, related to signals that it is not capable of transmitting or receiving.

In some examples, when providing navigation assistance, the user device 105 may provide audio feedback to the user instead of, or in addition to, graphical feedback. For example, in causing the radio signal information to be communicated to the user, the user device 105 may produce a series of clicks, similar to those produced by a Geiger counter, that are produced at a high rate when the user is moving in a direction toward a location at which radio connectivity is expected to be available, and that are produced at a low rate otherwise. When a foreign cellular carrier's signal is available, the user device 105 may prompt the user to turn on roaming, so as to be able to use the foreign carrier's network.

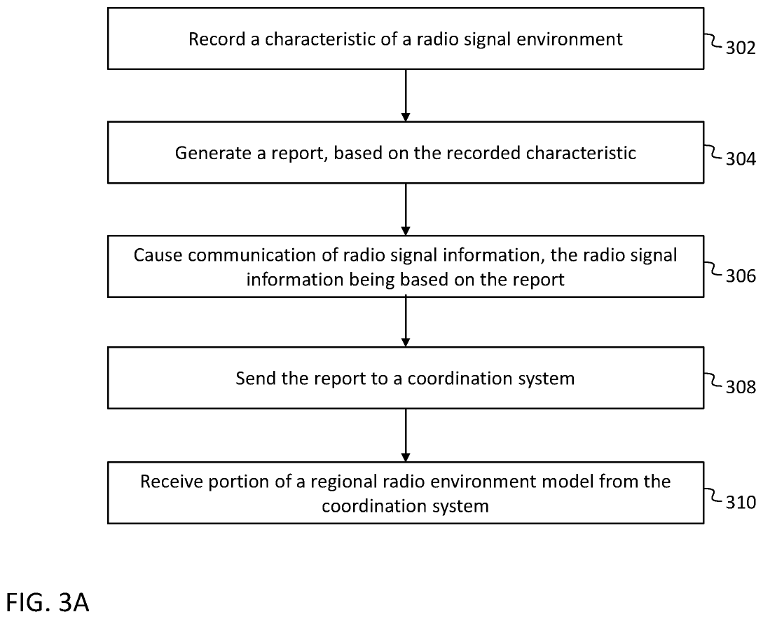

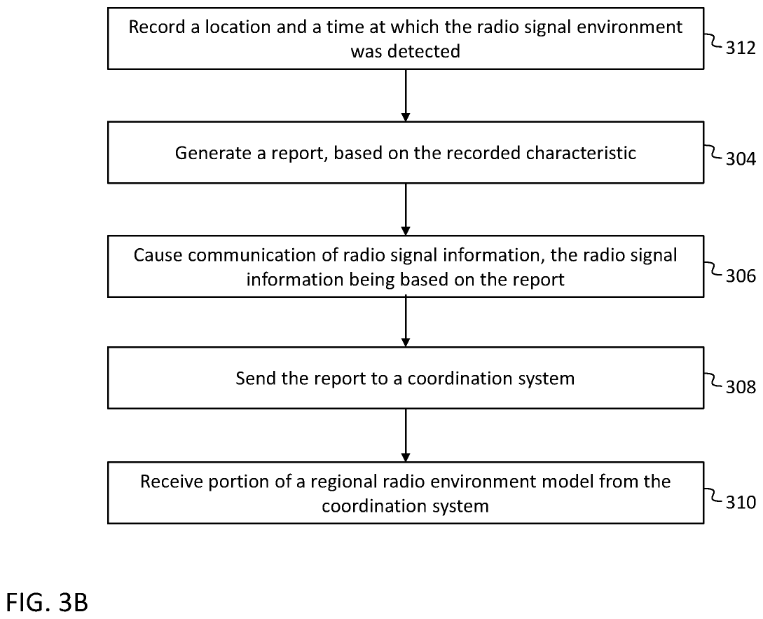

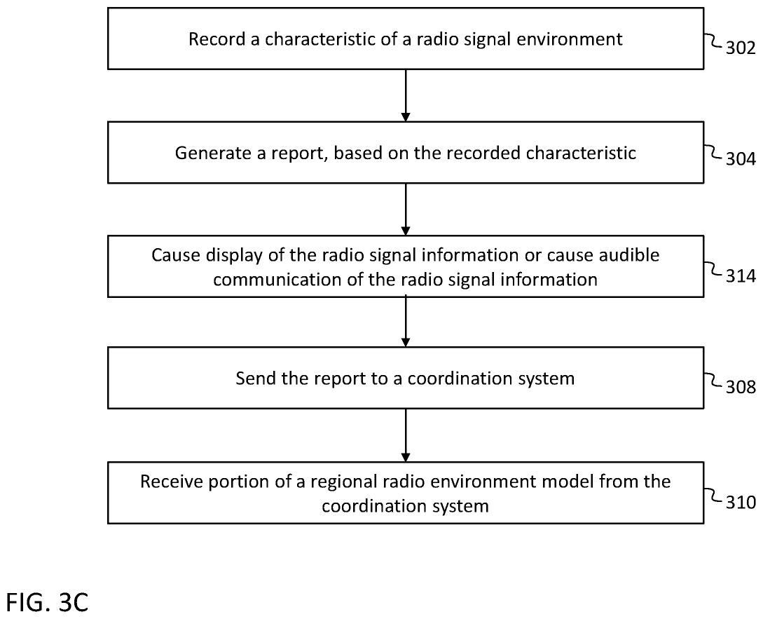

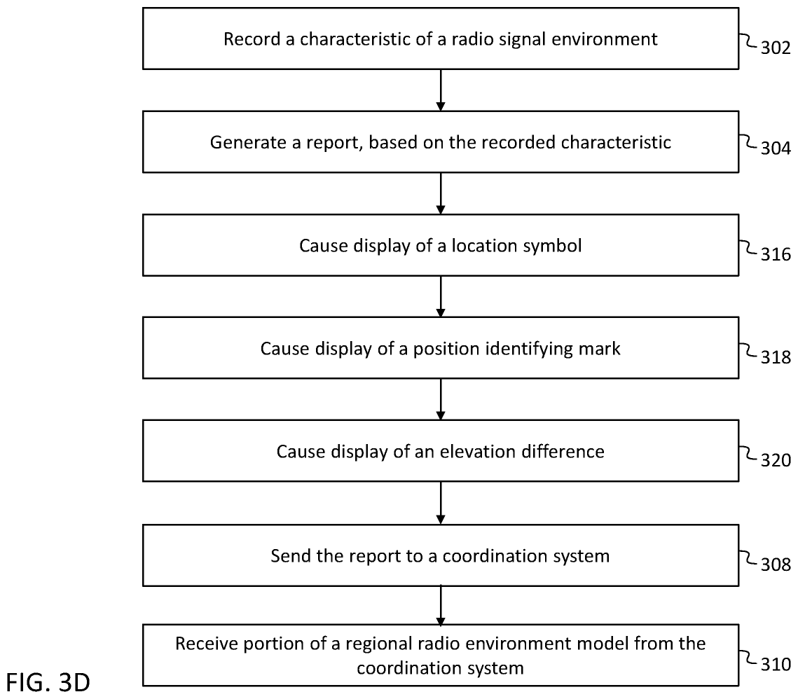

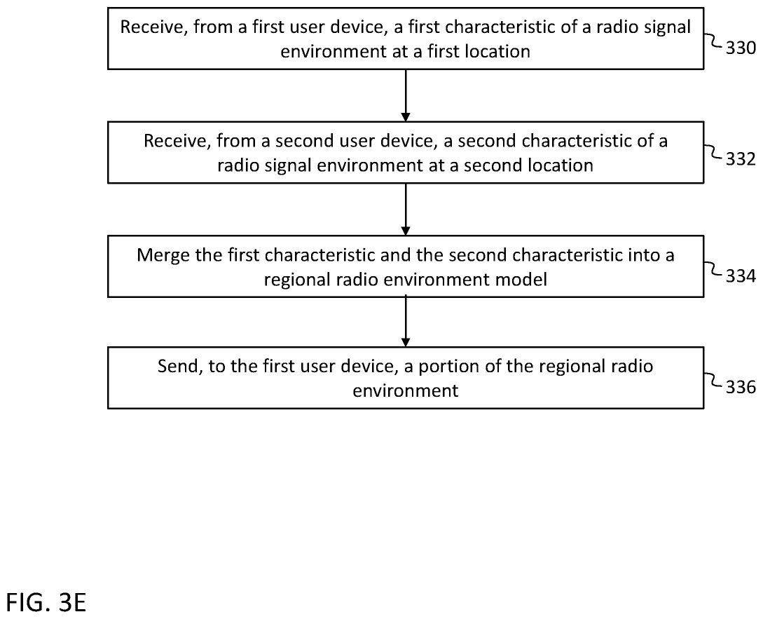

FIGS. 3A-3E are flowcharts of methods according to some examples described herein. Referring to FIG. 3A, in some examples, a characteristic of a radio signal environment is recorded at 302; a report is generated, at 304, based on the recorded characteristic; communication of radio signal information is caused, at 306, the radio signal information being based on the report; the report is sent, at 308, to a coordination system; and a portion of a regional radio environment model is received, at 310, from the coordination system. Referring to FIG. 3B, in some examples, the recording (at 302, in FIG. 3A), of the characteristic of the radio signal environment includes recording, at 312, a location and a time at which the radio signal environment was detected. As used herein, a “report” is any collection of data, and, for example, the collecting and storing (or recording) of information about the radio environment that the user device may perform constitutes “generating a report” as used herein.

Referring to FIG. 3C, in some examples, the causing (at 306, in FIG. 3A), communication of radio signal information includes, at 314, at least one of causing display of the radio signal information or causing audible communication of the radio signal information.

Referring to FIG. 3D, in some examples, the causing (at 306, in FIG. 3A), communication of radio signal information includes causing, at 316, display of a location symbol corresponding to a location at which radio connectivity is expected to be available; causing, at 318, display of a position identifying mark corresponding to the position of the user device; and causing, at 320, display, with the location symbol, of an elevation difference between the location at which radio connectivity is expected to be available and the position of the user device.

Referring to FIG. 3E, in some examples, a method includes receiving, at 330, from a first user device, a first characteristic of a radio signal environment at a first location; receiving, at 332, from a second user device, a second characteristic of a radio signal environment at a second location; merging, at 334, the first characteristic and the second characteristic into a regional radio environment model; and sending, at 336, to the first user device, a portion of the regional radio environment model, the portion being based on the location of the first user device.

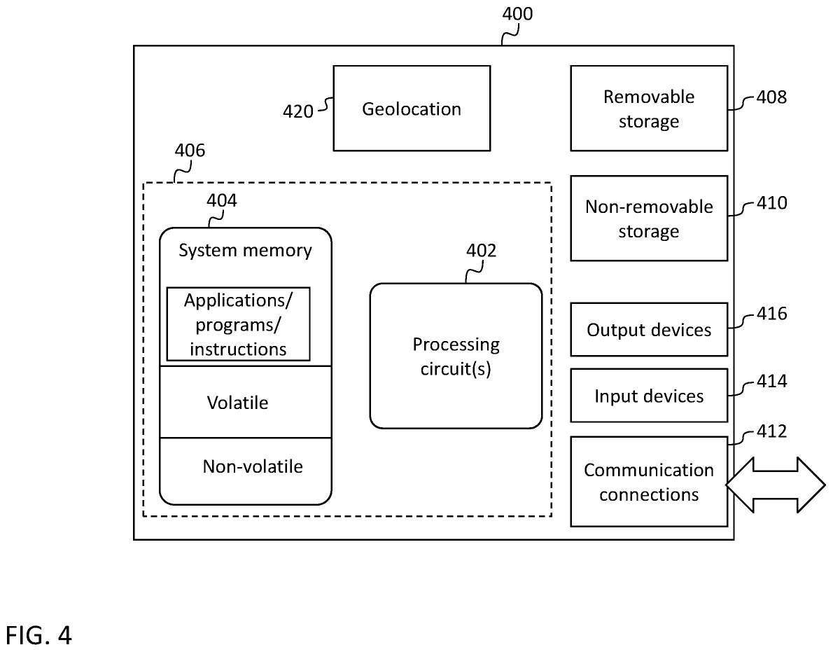

FIG. 4 depicts an example of a suitable operating environment 400, portions of which may be used to implement a portion of a user device 105 or of the coordination system 130. In its most basic configuration, operating environment 400 typically includes at least one processing circuit 402 and memory 404. The processing circuit may be a processor, which is hardware. Depending on the exact configuration and type of computing device, memory 404 (storing instructions to perform the methods disclosed herein) may be volatile (such as RAM), non-volatile (such as ROM, flash memory, etc.), or some combination of the two. This most basic configuration is illustrated in FIG. 4 by dashed line 406. The memory 404 stores instructions that, when executed by the processing circuit(s) 402, perform the processes and operations described herein. Further, environment 400 may also include storage (removable 408, or non-removable 410) including, but not limited to, solid-state, magnetic disks, optical disks, or tape. Similarly, environment 400 may also have input device(s) 414 such as keyboard, mouse, pen, voice input, etc., or output device(s) 416 such as a display, speakers, printer, etc. Additional communication connections 412 may also be included that allow for further communication with LAN, WAN, point-to-point, etc. Operating environment 400 may also include geolocation devices 420, such as a global positioning system (GPS) device.

Operating environment 400 typically includes at least some form of computer readable media. Computer readable media can be any available media that can be accessed by processing circuit 402 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is non-transitory and tangible and does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of any of the above should also be included within the scope of computer readable media.

As used herein, the word “or” is inclusive, so that, for example, “A or B” means any one of (i) A, (ii) B, and (iii) A and B. As used herein, when a method or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the operating environment 400 on the single integrated circuit (chip). Examples of the present disclosure may also be practiced using other technologies capable of performing logical operations such as, for example, AND, OR, and NOT, including but not limited to mechanical, optical, fluidic, and quantum technologies.

Although exemplary examples of systems and methods to map localized wireless coverage have been specifically described and illustrated herein, many modifications and variations will be apparent to those skilled in the art. Accordingly, it is to be understood that systems and methods to map localized wireless coverage constructed according to principles of this disclosure may be embodied other than as specifically described herein. The invention is also defined in the following claims, and equivalents thereof.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method, comprising:
recording, by a user device, a characteristic of a radio signal environment;
generating a report, by the user device, based on the recorded characteristic; and
causing communication of radio signal information, wherein the radio signal information is based on the report.

2. The method of claim 1, wherein the characteristic includes a signal strength of a wireless signal and an identity of a carrier of the wireless signal.

3. The method of claim 1, wherein the recording comprises recording a location and a time at which the radio signal environment was detected.

4. The method of claim 1, wherein the characteristic includes a signal strength of a WiFi access point station.

5. The method of claim 1, further comprising sending, by the user device, to a coordination system, the report.

6. The method of claim 5, further comprising receiving, by the user device, from the coordination system, a portion of a regional radio environment model.

7. The method of claim 1, wherein the causing communication of radio signal information comprises at least one of causing display, by the user device, of the radio signal information or causing audible communication, by the user device, of the radio signal information.

8. The method of claim 7, wherein the radio signal information comprises a radio environment diagram, the radio environment diagram including:
a location symbol corresponding to a location at which radio connectivity is expected to be available; and
a position identifying mark corresponding to the position of the user device.

9. The method of claim 8, further comprising causing display, with the location symbol, of an elevation difference between the location at which radio connectivity is expected to be available and the position of the user device.

10. A user device, comprising:
a radio transceiver;
at least one processing circuit; and
memory, operatively connected to the at least one processing circuit and storing instructions that, when executed by the at least one processing circuit, cause the user device to perform a method, the method comprising:
recording a characteristic of a radio signal environment;
generating a report based on the recorded characteristic; and
causing communication of radio signal information, wherein the radio signal information is based on the report.

11. The user device of claim 10, wherein the characteristic includes a signal strength of a wireless signal and an identity of a carrier of the wireless signal.

12. The user device of claim 10, wherein the recording comprises recording a location and a time at which the radio signal environment was detected.

13. The user device of claim 10, wherein the characteristic includes a signal strength of a WiFi access point station.

14. The user device of claim 10, wherein the at least one processing circuit is further configured to send the report to a coordination system.

15. The user device of claim 14, wherein the method further comprises receiving, from the coordination system, a portion of a regional radio environment model.

16. The user device of claim 10, wherein the causing communication of radio signal information comprises at least one of causing display, by the user device, of the radio signal information or causing audible communication, by the user device, of the radio signal information.

17. The user device of claim 16, wherein the radio signal information comprises a radio environment diagram, the radio environment diagram including:
a location symbol corresponding to a location at which radio connectivity is expected to be available; and
a position identifying mark corresponding to the position of the user device.

18. The user device of claim 17, wherein the method further comprises causing display, with the location symbol, of an elevation difference between the location at which radio connectivity is expected to be available and the position of the user device.

19. A system, comprising:
at least one processing circuit; and
memory, operatively connected to the at least one processing circuit and storing instructions that, when executed by the at least one processing circuit, cause the at least one processing circuit to perform a method, the method comprising:
receiving, from a first user device, a first characteristic of a radio signal environment at a first location;
receiving, from a second user device, a second characteristic of a radio signal environment at a second location;
merging the first characteristic and the second characteristic into a regional radio environment model; and
sending, to the first user device, a portion of the regional radio environment model, the portion being based on the location of the first user device.

20. The system of claim 19, wherein the portion is further based on the capabilities of the first user device.
